(19) United States
(12) Patent Application Publication
(10) Pub. No.: US 2015/0116202 A1
(43) Pub. Date: Apr. 30, 2015

(54) IMAGE PROCESSING DEVICE AND METHOD, AND PROGRAM

(71) Applicant: Sony Corporation, Tokyo (JP)

(72) Inventor: Yoshihiko Kuroki, Kanagawa (JP)

(73) Assignee: Sony Corporation, Tokyo (JP)

(21) Appl. No.: 14/381,248

(22) PCT Filed: Feb. 25, 2013
(86) PCT No.: PCT/JP2013/054670

§ 371 Date: Aug. 27, 2014

(30) Foreign Application Priority Data
Mar. 7, 2012 (JP) 2012-050211

(51) Int. Cl. G06F 3/01

(52) U.S. Cl. CPC G06F 3/013
USPC 345/156

(57) ABSTRACT

The present technology relates to an image processing device and a method thereof, and a program which can present a more natural stereoscopic image.

A photographing unit photographs a plurality of pairs of images, each of which is formed of a right eye image and a left eye image. In addition, the photographing unit also photographs a wide angle right eye image in which an object of each right eye image is included, and a wide angle left eye image in which an object of each left eye image is included. A position determination unit arranges a plurality of the right eye images on a coordinate system in which the wide angle right eye image is a standard, and arranges a plurality of the left eye images on a coordinate system in which the wide angle left eye image is a standard based on a plurality of pairs of images of which convergence points are different. A composition processing unit composites the right eye image which is arranged on the coordinate system, and composites the left eye image which is arranged on the coordinate system. In this manner, it is possible to obtain a stereoscopic image with a plurality of convergence points, which is formed of composited right eye image and left eye image. The present technology can be applied to an image processing device.

### TECHNICAL FIELD

The present technology relates to an image processing device, a method thereof, and a program, and in particular, to an image processing device, a method thereof, and a program which are capable of presenting a more natural stereoscopic image.

### BACKGROUND ART

In the related art, a technology in which a right eye image and a left eye image are photographed using a plurality of photographing units, and a stereoscopic image is presented from these right eye image and left eye image has been known.

As such a technology, a technology in which a face of a person is detected from a right eye image and a left eye image which are photographed so that optical axes of two photographing units become parallel to each other, and a convergence angle is adjusted according to a detection result thereof has been presented (for example, refer to PTL 1).

### CITATION LIST

### Patent Literature

PTL 1: Japanese Unexamined Patent Application Publication No. 2008-22150

### SUMMARY OF INVENTION

### Technical Problem

Meanwhile, a convergence point of a stereoscopic image which is obtained using the above described technology, that is, a point at which two optical axes of photographing units cross becomes one with respect to one stereoscopic image. Accordingly, in a case in which a user gazes at a position which is different from a position at which the photographing unit converges on a stereoscopic image when the obtained stereoscopic image is viewed by the user, parallax distribution of the stereoscopic image becomes different from that when a real object is viewed, and a sense of incompatibility occurs.

For example, as illustrated in FIG. 1, it is assumed that a user observes two objects OB11 and OB12 using a right eye ER and a left eye EL.

Specifically, for example, it is assumed that the user gazes at a point P1 which is an apex of the object OB11 as illustrated on the left side in the figure. In the example, since a straight line PL11 is a gaze direction of the left eye EL of the user, and a straight line PL12 is a gaze direction of the right eye ER of the user, the point P1 becomes a convergence point.

In this case, as denoted by an arrow Q11 on the right side in the figure, a side surface SD11 on the left side of the object OB11 in the figure is observed, however, a side surface SD12 on the right side of the object OB11 in the figure is not observed in the left eye EL of the user. In addition, a side surface SD13 on the left side of the object OB12 in the figure is observed, however, a side surface SD14 on the right side of the object OB12 in the figure is not observed in the left eye EL of the user.

In addition, as denoted by an arrow Q12 on the right side in the figure, the side surface SD11 on the left side, and the side surface SD12 on the right side of the object OB11 are observed, and the side surface SD13 on the left side, and the side surface SD14 on the right side of the object OB12 are observed in the right eye ER of the user.

In contrast to this, for example, it is assumed that the user gazes at a point P2 which is an apex of the object OB12. In the example, since a straight line PL13 is a gaze direction of the left eye EL of the user, and a straight line PL14 is a gaze direction of the right eye ER of the user, the point P2 becomes a convergence point.

Accordingly, in this case, as denoted by an arrow Q13 on the right side in the figure, the side surface SD11 on the left side and the side surface SD12 on the right side of the object OB11 are observed, and the side surface SD13 on the left side and the side surface SD14 on the right side of the object OB12 are observed in the left eye EL of the user.

In addition, as denoted by an arrow Q14 on the right side in the figure, the side surface SD12 on the right side of the object OB11 is observed, however, the side surface SD11 on the left side of the object OB11 is not observed in the right eye ER of the user. In addition, the side surface SD14 on the right side of the object OB12 is observed, however, the side surface SD13 on the left side of the object OB12 is not observed in the right eye ER of the user.

In this manner, when a position of a convergence point is different, an appearance of an object which is observed in the left and right eyes of the user becomes different, even when a face of the user is at the same position. That is, parallax distribution becomes different. For example, when a gaze direction changes by as much as 15°, the surface of an eye lens of a person moves approximately by 3.6 mm, and accordingly, such a change in parallax distribution occurs, however, when a user turns his/her face, an amount of movement on the surface of the eye lens becomes larger, and the change in the parallax distribution also becomes large to that extent.

As described above, when a user observes an object in practice, parallax distribution becomes different depending on a position of a convergence point. Accordingly, in a stereoscopic image with single convergence, when a user gazes at a position which is different from a convergence point on a stereoscopic image, parallax distribution becomes different from that when a real object is observed, and an unnatural feeling is caused in the user.

In particular, the eyes of a person are sensitive to parallax, and such a difference in parallax distribution is perceived by a user. For example, sensitivity of a person with respect to spatial resolution is order of an angle, however, in contrast to this, sensitivity of a person with respect to parallax is approximately one order higher compared to a case of sensitivity with respect to spatial resolution. For this reason, a difference in parallax distribution when a user gazes a position which is different from a convergence point becomes one factor causing an unnatural impression due to the difference from a substance.

The present technology has been made in view of such a situation, and is for presenting a more natural stereoscopic image.

### Solution to Problem

According to an aspect of the present technology, there is provided an image processing device which includes a position determination unit which arranges a viewpoint image on a new coordinate system so that the same object on the viewpoint images is overlapped in each viewpoint, based on a plurality of image groups, each of which is formed of a plurality of viewpoint images with different viewpoints, and which have gaze points which are different from each other; and a composition processing unit which generates a stereoscopic image with a plurality of gaze points which is formed of a composite viewpoint image of each of the viewpoints, by generating the composite viewpoint image by compositing the plurality of viewpoint images which are arranged on the coordinate system, in each of the viewpoints.

The image group in each of the gaze points may be formed of a pair of viewpoint images, respectively, and may have one convergence point.

The composition processing unit may generate the composite viewpoint image by performing an adding and averaging filtering process with respect to the viewpoint images by performing weighting corresponding to a position in a region in which the plurality of viewpoint images are overlapped.

The plurality of image groups may be photographed at the same point in time.

The plurality of image groups may be photographed at a different point in time in each of the image groups.

According to an aspect of the present technology, there is provided an image processing method, or a program which includes the steps of arranging a viewpoint image on a new coordinate system so that the same object on the viewpoint images is overlapped in each of viewpoints, based on a plurality of image groups which are formed of viewpoint images with different viewpoints, and have gaze points which are different from each other; and generating a stereoscopic image with a plurality of gaze points which is formed of a composite viewpoint image of each the viewpoint, by generating the composite viewpoint image by compositing the plurality of viewpoint images which are arranged on the coordinate system, in each the viewpoint.

According to an aspect of the present technology, a viewpoint image is arranged on a new coordinate system so that the same object on the viewpoint images is overlapped in each viewpoint, based on a plurality of image groups, each of which is formed of a plurality of viewpoint images with different viewpoints, and which have gaze points which are different from each other; and a stereoscopic image with a plurality of gaze points which is formed of a composite viewpoint image of each the viewpoint is generated, by generating the composite viewpoint image by compositing the plurality of viewpoint images which are arranged on the coordinate system, in each the viewpoint.

### Advantageous Effects of Invention

According to one aspect the present technology, it is possible to present a more natural stereoscopic image.

### BRIEF DESCRIPTION OF DRAWINGS

FIG. 1 is a diagram which describes a difference in appearance of an object due to a convergence point.

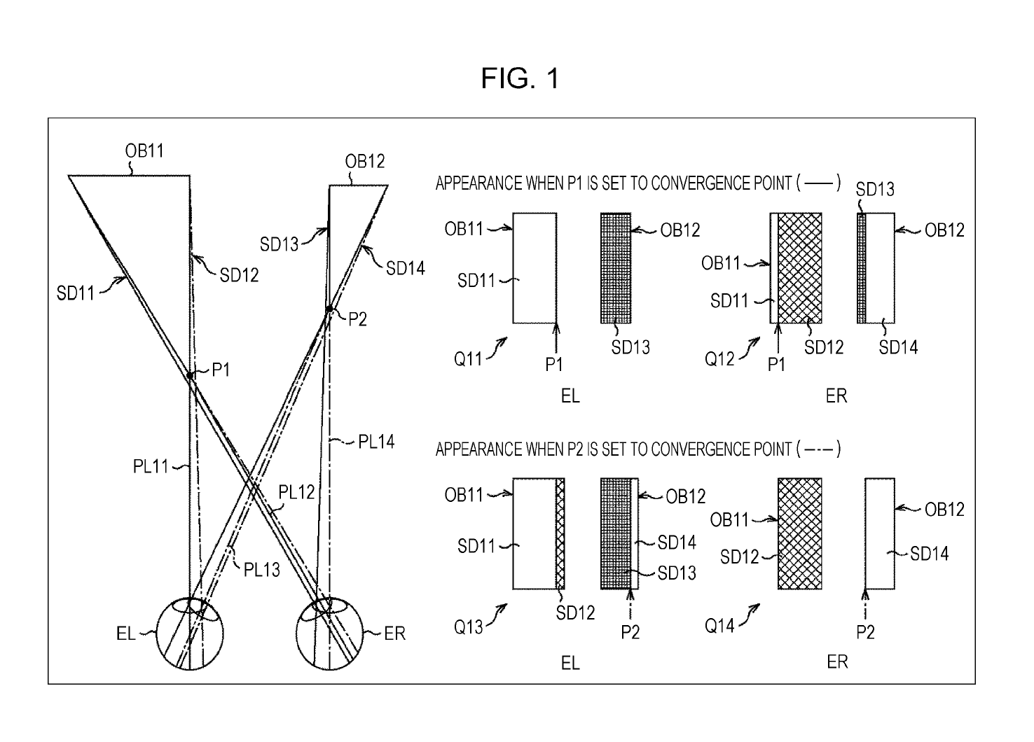

FIG. 2 is a diagram which describes a composition of images of which convergence points are different.

FIG. 3 is a diagram which describes parallax of a stereoscopic image.

FIG. 4 is a diagram which describes photographing of a plurality of images of which convergence points are different.

FIG. 5 is a diagram which illustrates a configuration example of a display processing system.

FIG. 6 is a flowchart which describes generation processing of a stereoscopic image.

FIG. 7 is a diagram which illustrates a configuration example of a computer.

### DESCRIPTION OF EMBODIMENTS

Hereinafter, embodiments to which the present technology is applied will be described with reference to drawings.

### First Embodiment

### Generation of Stereoscopic Image

The present technology is a technology for generating a more natural stereoscopic image not causing a sense of incompatibility when a user views. First, a generation of a stereoscopic image using the present technology will be described.

A stereoscopic image which is generated using the present technology is formed of a left eye image which is observed using a left eye of a user, and a right eye image which is observed using a right eye of the user, when performing a stereoscopic display, for example. In addition, the stereoscopic image may be an image which is formed of a viewpoint image with three or more different viewpoints, however, hereinafter, descriptions will be continued by assuming that the stereoscopic image is formed of a left eye image and a right eye image which are two different viewpoint images, for ease of description.

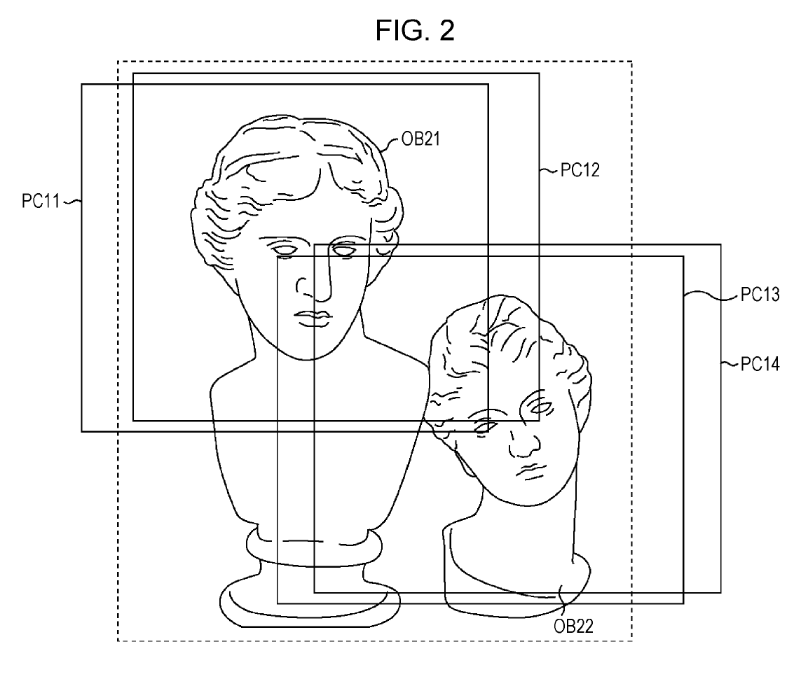

According to the present technology, a plurality of images of which convergence points are different are used when generating one stereoscopic image. That is, a pair of images which is formed of a left eye image and a right eye image having a predetermined convergence point is prepared for each of a plurality of convergence points which are different. For example, when a right eye image which configures a stereoscopic image is being paid attention to, as illustrated in FIG. 2, four right eye images PC11 to PC14 of which convergence points are different are composited, and a final right eye image is generated.

In the example in FIG. 2, the right eye images PC11 to PC14 are images which are obtained by photographing busts OB21 and OB22 of two persons as objects.

For example, the right eye image PC11 is an image which is photographed so that a position of a right eye of the bust OB21 becomes a convergence point, and the right eye image PC12 is an image which is photographed so that a position of a left eye of the bust OB21 becomes a convergence point. In addition, the right eye image PC13 is an image which is photographed so that a position of a right eye of the bust OB22 becomes a convergence point, and the right eye image PC14 is an image which is photographed so that a position of a left eye of the bust OB22 becomes a convergence point.

According to the present technology, these four right eye images PC11 to PC14 of which convergence points are different are arranged on a new coordinate system (plane) so that the same object on the images is overlapped. In addition, the overlapped right eye images PC11 to PC14 are composited so as to be smoothly connected, and become one final right eye image (hereinafter, referred to as right eye composite image).

At this time, for example, in a region in which the plurality of right eye images are overlapped with each other, the right eye image is composited using a weight corresponding to a position in the overlapped region.

Specifically, the right eye composite image is generated, for example, by compositing the right eye image PC11 and the right eye image PC13, that is, by these being subjected to weighted addition. At this time, at a position which is closer to the right eye image PC11 in a region in which the right eye image PC11 and the right eye image PC13 are overlapped, a weight with respect to the right eye image PC11 becomes larger than a weight with respect to the right eye image PC13. Here, the position which is closer to the right eye image PC11 in the region in which the right eye image PC11 and the right eye image PC13 are overlapped is assumed to be a position which is closer to a center of the right eye image PC11 than a center position of the right eye image PC13, for example.

Similarly to the case in the right eye image, it is assumed that one final left eye image (hereinafter, referred to as left eye composite image) is generated by compositing a plurality of left eye images of which convergence points are different.

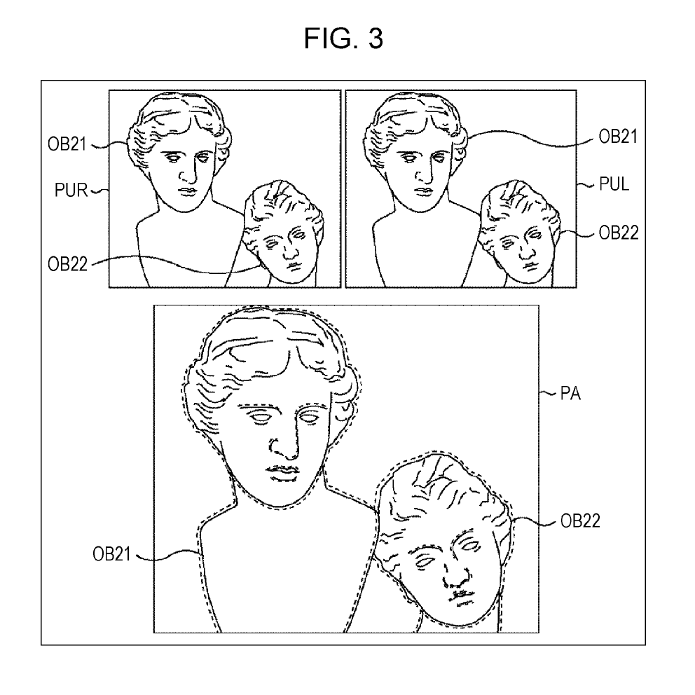

In this manner, for example, as illustrated in FIG. 3, a stereoscopic image which is formed of a right eye composite image PUR and a left eye composite image PUL is obtained. In addition, in FIG. 3, the same reference numerals are given to portions corresponding to the case in FIG. 2, and descriptions thereof will be appropriately omitted.

When a mean value of pixels in the same position on the right eye composite image and the left eye composite image is set to a new pixel with respect to the right eye composite image PUR and a left eye composite image PUL which are obtained by compositing the plurality of images of which convergence points are different, a sum and averaged image PA which is illustrated on the lower side in the figure is obtained.

In the sum and averaged image PA, contours of the bust OB21 and the bust OB22 as objects are blurred. The blurry contours are caused by parallax between the right eye composite image PUR and the left eye composite image PUL, however, an amount of blurring of the contour of the bust OB21 or the bust OB22 in the sum and averaged image PA is small, and it is understood that the parallax of the right eye composite image PUR and the left eye composite image PUL is appropriate.

For example, in a region in the vicinity of the right eye of the bust OB21 as the object, the parallax of the right eye composite image PUR and the left eye composite image PUL becomes a value which is close to the parallax of a right eye image and a left eye image which are photographed by setting the position of the right eye of the bust OB21 to a convergence point. That is, in the region in the vicinity of the right eye of the bust OB21 in a stereoscopic image, parallax distribution becomes that which is close to a case in which a user actually gazes at the right eye of the bust OB21.

Similarly, for example, in a region in the vicinity of the left eye of the bust OB22 as the object, the parallax of the right eye composite image PUR and the left eye composite image PUL becomes a value which is close to the parallax of a right eye image and a left eye image which are photographed by setting the position of the left eye of the bust OB22 to a convergence point. For this reason, in the region in the vicinity of the left eye of the bust OB22 in a stereoscopic image, parallax distribution becomes that which is close to a case in which a user actually gazes at the left eye of the bust OB22.

As described with reference to FIG. 2, for example, this is because the right eye composite image PUR and the left eye composite image PUL are generated by compositing each image so that images with different convergence points are smoothly connected by being weighted.

It is possible to provide a plurality of convergence points on a stereoscopic image by generating the right eye composite image PUR and the left eye composite image PUL in this manner, and to reduce contradiction of the parallax distribution which causes unnaturalness that a user feels. That is, it is possible to present a more natural stereoscopic image by improving consistency of the parallax distribution in each portion of the stereoscopic image.

In addition, as described above, according to the present technology, the right eye composite image PUR or the left eye composite image PUL is generated by compositing a plurality of images of which convergence points are different. For this reason, for example, when a user gazes at one convergence point on a stereoscopic image, parallax distribution in a region in the vicinity of another convergence point becomes different from parallax distribution when the user actually views an object. However, in a region to which the user does not pay attention, the user does not feel unnaturalness due to an error thereof, even when there is some error in parallax distribution due to a nature of a living body of which a definition ability of eyes is lowered in peripheral vision.

In addition, a convergence point of the right eye image and the left eye image for obtaining the right eye composite image PUR and the left eye composite image PUL is positioned at a portion of an object to which there is a high possibility that a user may pay attention.

For example, when an object is a person, a user usually pays attention to the eyes or a texture portion of the person as the object. Therefore, a plurality of pairs of right eye images and left eye images which are photographed by setting the portion to which there is a high possibility that the user may pay attention to a convergence point are prepared, the right eye images, or the left eye images are connected by compositing thereof so that a boundary thereof is obscured, and a right eye composite image and a left eye composite image may be generated.

Regarding Photographing of Images with Different Convergence Points

Hitherto, a right eye composite image and a left eye composite image which configure a stereoscopic image according to the present technology have been described as being generated by compositing a plurality of right eye images or left eye images of which convergence points are different, respectively. Subsequently, photographing of a right eye image and a left eye image which are used when generating the right eye composite image and the left eye composite image will be described.

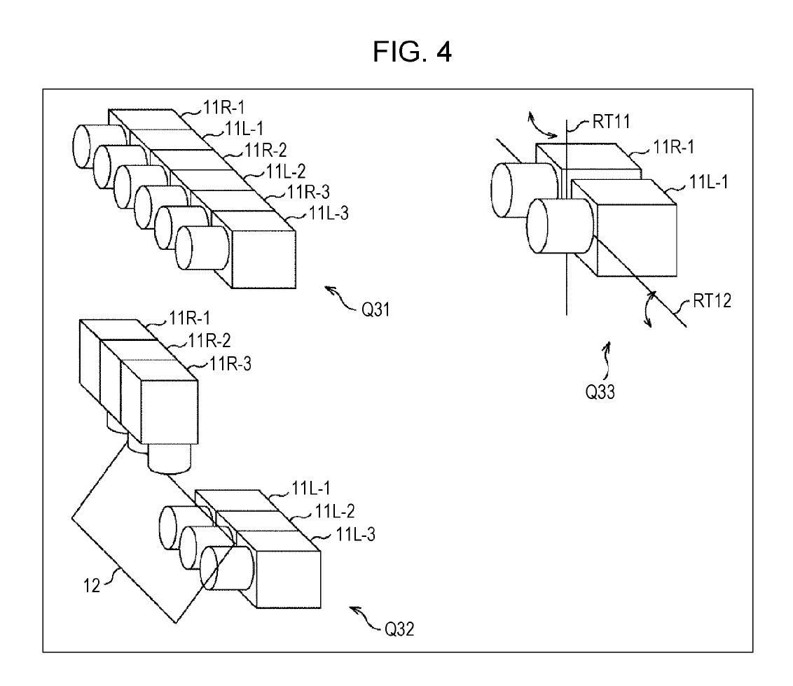

As denoted by an arrow Q31 in FIG. 4, for example, a plurality of right eye images or left eye images of which convergence points are different can be obtained by performing photographing, by arranging a plurality of photographing devices side by side in a direction which is approximately orthogonal to an optical axis of each photographing device.

In the example denoted by the arrow Q31, photographing devices 11R-1, 11L-1, 11R-2, 11L-2, 11R-3, and 11L-3 are arranged side by side in order in a forward direction from a deep side in the figure.

Here, the photographing devices 11R-1, 11R-2, and 11R-3 are photographing devices for photographing right eye images of which convergence points are different from each other. In addition, the photographing devices 11L-1, 11L-2, and 11L-3 are photographing devices for photographing left eye images of which convergence points are different from each other.

That is, in the example, the photographing devices 11R-1 and 11L-1, 11R-2 and 11L-2, and 11R-3 and 11L-3 are pairs of photographing devices of which the convergence points are different, respectively.

In addition, hereinafter, when it is not particularly necessary to classify the photographing devices 11R-1 to 11R-3, the photographing devices are simply referred to also as the photographing device 11R, and when it is not particularly necessary to classify the photographing devices 11L-1 to 11L-3, the photographing devices are simply referred to also as the photographing device 11L.

In addition, as denoted by an arrow Q32, the photographing devices 11R and 11L may be arranged by being divided. In the example, a half mirror 12 which transmits a half of light from a direction of an object, and reflects a remaining half thereof is arranged.

In addition, the photographing devices 11L-1, 11L-2, and 11L-3 are arranged in order in the forward direction from the deep side, on the right side of the half mirror 12 in the figure. In addition, the photographing devices 11R-1, 11R-2, and 11R-3 are arranged in order in the forward direction from the deep side, on the upper side of the half mirror 12 in the figure.

Accordingly, in this case, each photographing device 11L photographs a left eye image by receiving light which is emitted from an object, and penetrates the half mirror 12, and each photographing device 11R photographs a right eye image by receiving light which is emitted from the object, and is reflected on the half mirror 12.

In addition, in the example which is denoted by the arrow Q32, when viewing in a direction of the half mirror 12 from the photographing device 11R, an optical axis of each photographing device 11R is located between optical axes of photographing devices 11L which are neighboring each other. For example, an optical axis of the photographing device 11R-1 is located between optical axes of the photographing devices 11L-1 and 11L-2. By arranging the photographing devices 11R and 11L in this manner, it is possible to make a distance between optical axes of the photographing devices 11R and 11L which become a pair shorter compared to the case of the arrow Q31. In addition, in the examples which are denoted by the arrows Q31 and Q32, three pairs of images, each of which is formed with a right eye image and a left eye image with one convergence point, are photographed at the same point in time. That is, three pairs of images with different convergence points are photographed at the same time.

In addition, as denoted by an arrow Q33, a plurality of right eye images with different convergence points may be photographed approximately at the same time by one photographing device 11R-1, and a plurality of left eye images with different convergence points may be photographed approximately at the same time by one photographing device 11L-1.

In this case, in order to photograph a right eye image and a left eye image of which a convergence point is different, the photographing devices 11R-1 and 11L-1 are rotated about a straight line RT11 or RT12 which is approximately orthogonal to optical axes of those photographing devices. In this manner, it is possible to perform photographing while moving convergence points of the photographing devices 11R-1 and 11L-1 to arbitrary positions at high speed. In this case, for example, a pair of images which is formed of a right eye image and a left eye image with one convergence point is photographed at a different point in time for each convergence point.

For example, one frame period of a stereoscopic image is 1/60 seconds, and when a right eye image and a left eye image with four convergence points are to be obtained, cameras which can photograph 240 frames in one second may be used as the photographing devices 11R-1 and 11L-1. When an image is blurred due to a movement of the photographing device 11R-1 or 11L-1, an electronic shutter may be used, as well, so as to react thereto.

In addition, hitherto, a case in which a right eye image and a left eye image with different convergence points, that is, a stereo image with two viewpoints are photographed has been described, however, a plurality of M viewpoints images which are formed of viewpoint images of M sheets with different viewpoints (here, 3M) may be photographed for each convergence point (gaze point).

In such a case, similarly to the case of the right eye image or the left eye image, a plurality of viewpoint images with an mth (here, 1≦m≦M) viewpoint of which convergence points are different are arranged on a new coordinate system with respect to each of M viewpoints so that the same object on those viewpoint images is overlapped. In addition, a composite viewpoint image is generated by compositing each viewpoint image with the mth viewpoint which is arranged on the new coordinate system, and a stereoscopic image which is formed of a composite viewpoint image of each of M viewpoints, that is, an image of M viewpoints is generated.

Hereinafter, a case in which a right eye image and a left eye image are photographed and displayed as a stereoscopic image will be further described subsequently.

### Configuration Example of Display Processing System

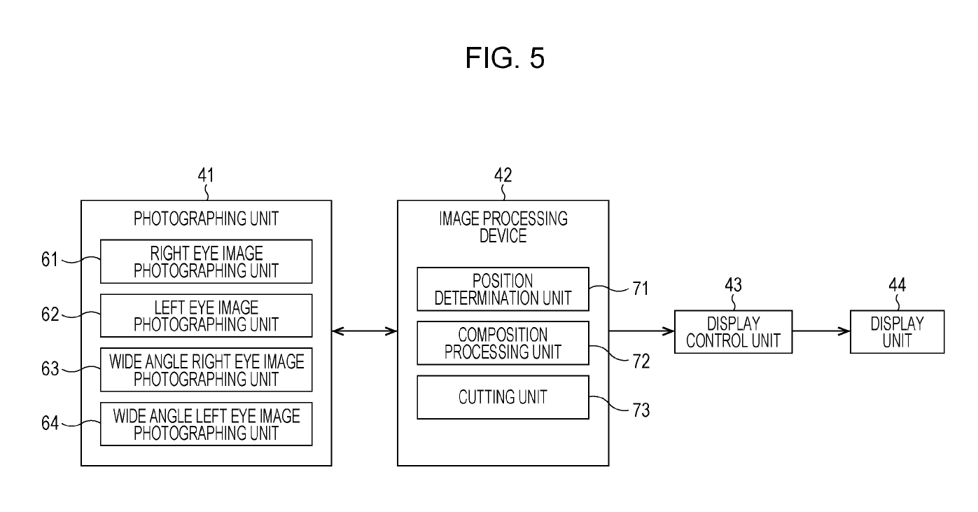

Subsequently, a specific embodiment to which the present technology is applied will be described. FIG. 5 is a diagram which illustrates a configuration example of one embodiment of a display processing system to which the present technology is applied.

The display processing system in FIG. 5 is configured of a photographing unit 41, an image processing unit 42, a display control unit 43, and a display unit 44.

The photographing unit 41 photographs a right eye image or a left eye image based on a control of the image processing unit 42, and supplies the image to the image processing unit 42. The photographing unit 41 includes a right eye image photographing unit 61, a left eye image photographing unit 62, a wide angle right eye image photographing unit 63, and a wide angle left eye image photographing unit 64.

The right eye image photographing unit 61 and the left eye image photographing unit 62 are a pair of photographing devices which photographs a right eye image and a left eye image with a predetermined convergence point, and for example, the right eye image photographing unit 61 and the left eye image photographing unit 62 correspond to the photographing devices 11R-1 and 11L-1 which are denoted by the arrow Q33 in FIG. 4.

In addition, the right eye image photographing unit 61 may be formed of the photographing devices 11R-1 to 11R-3 which are denoted by the arrow Q31 or Q32 in FIG. 4, and the left eye image photographing unit 62 may be formed of the photographing devices 11L-1 to 11L-3 which are denoted by the arrow Q31 or Q32 in FIG. 4.

The right eye image photographing unit 61 and the left eye image photographing unit 62 photograph a plurality of right eye images and left eye images with different convergence points, and supply the obtained right eye images and left eye images to the image processing unit 42.

In addition, hereinafter, it is assumed that a pair of a right eye image and a left eye image is photographed with respect to N different convergence points, and the nth (here, 1≦n≦N) right eye image and left eye image are also referred to as a right eye image Rₙ and a left eye image Lₙ, respectively. A pair of images which is formed of the right eye image Rₙ and the left eye image Lₙ is a pair of images with one convergence point.

In addition, the wide angle right eye image photographing unit 63 and the wide angle left eye image photographing unit 64 photograph a wide angle image which is wider than each right eye image Rₙ and left eye image Lₙ as a wide angle right eye image R_{g} and a wide angle left eye image L_{g}, and supply the images to the image processing unit 42. That is, the wide angle right eye image R_{g} is an image in which the entire object on each right eye image Rₙ is included, and the wide angle left eye image L_{g} is an image in which the entire object on each left eye image Lₙ is included.

The image processing unit 42 generates a right eye composite image and a left eye composite image based on the right eye image Rₙ and the left eye image Lₙ, and the wide angle right eye image R_{g} and the wide angle left eye image L_{g} which are supplied from the photographing unit 41, and supplies the images to the display control unit 43. The image processing unit 42 includes a position determination unit 71, a composition processing unit 72, and a cutting unit 73.

The position determination unit 71 determines a position of each right eye image Rₙ on a projected coordinate system so that each right eye image Rₙ overlaps with the wide angle right eye image R_{g} on a new coordinate system (hereinafter, referred to also as projected coordinate system) in which the wide angle right eye image R_{g} is a standard. For example, the projected coordinate system based on the wide angle right eye image R_{g} is a two-dimensional coordinate system in which a center position of the wide angle right eye image R_{g} is set to the origin.

In addition, similarly to the case of the right eye image Rₙ, the position determination unit 71 determines a position of each left eye image Lₙ on the projected coordinate system so that each left eye image Lₙ overlaps with the wide angle left eye image L_{g} on the projected coordinate system based on the wide angle left eye image L_{g} with respect to the left eye image Lₙ, as well.

The composition processing unit 72 composites the right eye image Rₙ which is arranged on the projected coordinate system, and composites the left eye image Lₙ which is arranged on the projected coordinate system. The cutting unit 73 generates a right eye composite image by cutting out (trimming) a predetermined region of an image which is obtained by compositing the right eye image Rₙ on the projected coordinate system, and generates a left eye composite image by cutting out a predetermined region of an image which is obtained by compositing the left eye image Lₙ on the projected coordinate system.

The display control unit 43 supplies the right eye composite image and the left eye composite image which are supplied from the image processing unit 42 to the display unit 44, and displays the images stereoscopically. The display unit 44 is formed of a stereoscopic display unit of a naked-eye system, or the like, for example, and displays a stereoscopic image by displaying the right eye composite image and the left eye composite image which are supplied from the display control unit 43.

### Description of Stereoscopic Image Generating Process

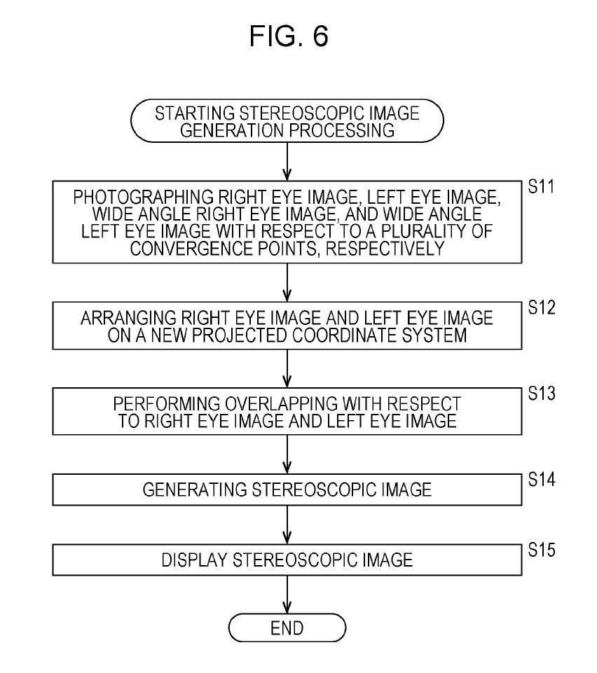

Meanwhile, when a generation and display of a stereoscopic image is instructed with respect to the display processing system in FIG. 5, the display processing system performs a stereoscopic image generating process, and displays a stereoscopic image. Hereinafter, the stereoscopic image generating process using the display processing system will be described with reference to a flowchart in FIG. 6.

In step S11, the photographing unit 41 photographs the right eye image Rₙ and the left eye image Lₙ with respect to each of a plurality of convergence points, and the wide angle right eye image R_{g} and the wide angle left eye image L_{g}.

That is, the right eye image photographing unit 61 and the left eye image photographing unit 62 photograph a right eye image Rₙ and a left eye image Lₙ (here, 1≦n≦N) with N convergence points, respectively, and supply the images to the image processing unit 42. In addition, the wide angle right eye image photographing unit 63 and the wide angle left eye image photographing unit 64 photograph a wide angle right eye image R_{g} and a wide angle left eye image L_{g}, and supply the images to the image processing unit 42.

In addition, at a time of photographing the right eye image Rₙ and the left eye image Lₙ, the right eye image Rₙ and the left eye image Lₙ may be photographed by setting a desired portion of an object which has a high possibility that a user may pay attention thereto to a convergence point due to a control of the image photographing unit 41 by the image processing unit 42.

In such a case, for example, the image processing unit 42 determines a region with high contrast, that is, a region with some luminance changes without being flat as a position of a convergence point from the wide angle right eye image R_{g} or the wide angle left eye image L_{g}, and controls the photographing unit 41 so that the region becomes the convergence point.

In addition, for example, when a face of a person is taken in a close-up manner in the wide angle right eye image R_{g}, or the wide angle left eye image L_{g}, the image processing unit 42 may select both eyes, or a center of the face of the person as the convergence point. In addition, for example, when a plurality of persons are taken in the wide angle right eye image R_{g}, or the wide angle left eye image L_{g}, a region of a face at a position in a center, on the left and right, or the like, of a screen may be selected as the convergence point among faces of the persons. In addition, when detecting a face of a person from the wide angle right eye image R_{g} or the wide angle left eye image L_{g}, a face recognition function may be used.

In step S12, the position determination unit 71 arranges the right eye image Rₙ and the left eye image Lₙ on a new projected coordinate system.

For example, the position determination unit 71 determines a position at which a region of a center portion of the right eye image Rₙ overlaps with the wide angle right eye image R_{g} maximally on the projected coordinate system in which the wide angle right eye image R_{g} is a standard, by obtaining a correlation or a difference absolute value sum between the right eye image Rₙ and the wide angle right eye image R_{g} with respect to each of the right eye images Rₙ. In addition, the position determination unit 71 arranges each of the right eye images Rₙ at a determined position.

Here, the region of the center portion of the right eye image Rₙ is set to be a circular region of h/2 in diameter, or the like, of which a center is a center of the right eye image Rₙ, when the height of the right eye image Rₙ is h, for example.

Similarly to the case of the right eye image Rₙ, the position determination unit 71 determines a position at which a region of a center portion of the left eye image Lₙ overlaps with the wide angle left eye image L_{g} maximally on the projected coordinate system in which the wide angle left eye image L_{g} is a standard with respect to each of the left eye images Lₙ, and arranges the left eye image Lₙ at the position. In this manner, those right eye images Rₙ are arranged on the projected coordinate system so that the same object of each of right eye images Rₙ is overlapped, and those left eye images Lₙ are arranged on the projected coordinate system so that the same object of each of left eye images Lₙ is overlapped.

In step S13, the composition processing unit 72 performs overlapping with respect to the right eye image Rₙ and the left eye image Lₙ which are arranged on the projected coordinate system.

Specifically, the composition processing unit 72 performs the adding and averaging filtering process using a Gaussian filter with respect to the right eye images Rₙ so that portions of each right eye image Rₙ, which overlap with each other, which are arranged on the projected coordinate system are smoothly continuous, and composites N right eye images Rₙ.

In addition, when the right eye images Rₙ which overlap with each other on the projected coordinate system are composited, the right eye image Rₙ may be transformed using a geometric transformation such as an affine transformation, or the like, so that corresponding points of those right eye images match (overlap), by searching for the corresponding points in a region in the vicinity of a boundary of those right eye images Rₙ. In such a case, each of the transformed right eye images Rₙ is overlapped using a weight corresponding to a position in a region in which those images are overlapped with each other. In this manner, each right eye image Rₙ is smoothly composited so that a boundary of the right eye images Rₙ which overlap with each other is obscured.

In addition, when each right eye image Rₙ is arranged on the projected coordinate system, a geometric transformation such as an affine transformation, or the like, may be performed with respect to the right eye image Rₙ so that each portion of each right eye image Rₙ overlaps with each portion of the wide angle right eye image R_{g}.

In addition, the composition processing unit 72 composites N left eye images Lₙ by performing the adding and averaging filtering process with respect to the left eye images Lₙ so that portions of each left eye image Lₙ, which overlap with each other, which are arranged on the projected coordinate system are smoothly continuous, similarly to the overlapping of the right eye images Rₙ.

In step S14, the cutting unit 73 generates a stereoscopic image based on the composited right eye image Rₙ and left eye image Lₙ, and supplies the image to the display control unit 43.

That is, the cutting unit 73 generates a right eye composite image by cutting out a predetermined region of an image which is obtained by compositing the right eye image Rₙ on the projected coordinate system, and generates a left eye composite image by cutting out a predetermined region of an image which is obtained by compositing the left eye image Lₙ on the projected coordinate system. In this manner, a stereoscopic image which is formed of the right eye composite image and the left eye composite image is obtained.

In step S15, the display control unit 43 supplies the stereoscopic image which is supplied from the cutting unit 73 to the display unit 44, and displays the stereoscopic image, and the stereoscopic image generating process is finished.

In addition, the stereoscopic image which is formed of the right eye composite image and the left eye composite image may be a still image, or a moving image. In addition, the stereoscopic image may be a multi-viewpoint image which is formed of an image with three or more viewpoints.

As described above, the display processing system composites a plurality of right eye images or left eye images of which convergence points are different, and generates a stereoscopic image which is formed of a right eye composite image and a left eye composite image.

Since the stereoscopic image which is obtained in this manner has a plurality of convergence points, it is possible to present a more natural stereoscopic image. That is, when a user observes a stereoscopic image, a difference from actual parallax distribution in each gaze point is suppressed, and it is possible to present a high quality stereoscopic image which is natural and easy to view.

In addition, in the above descriptions, a case in which the photographing unit 41 or the display control unit 43 is connected to the image processing unit 42 has been exemplified, however, the photographing unit 41 may be provided in the image processing unit 42, or the display control unit 43 and the display unit 44 may be provided in the image processing unit 42.

Meanwhile, a series of processes which is described above can be executed using hardware, or using software. When the series of processes is executed using software, a program which configures the software is installed in a computer. Here, a computer which is incorporated in exclusive hardware, a general-purpose personal computer, for example, which can execute various functions by installing various programs, or the like, is included as the computer.

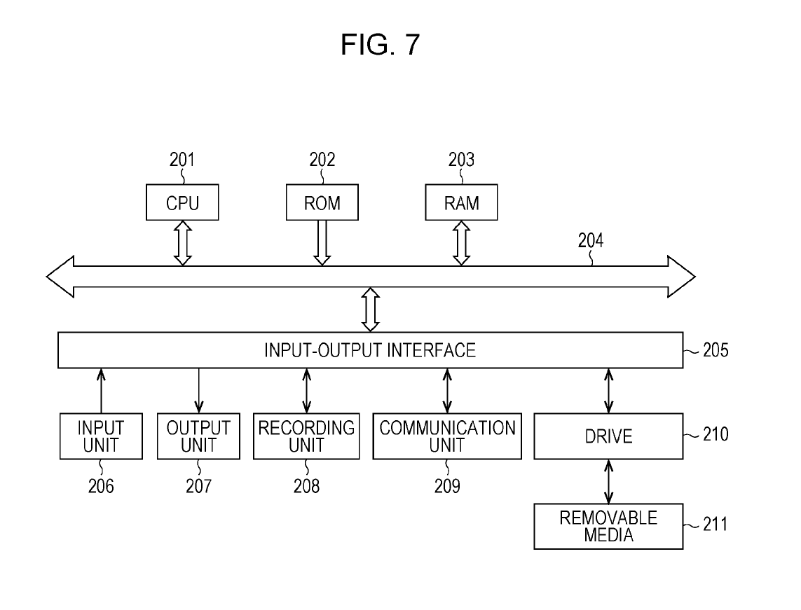

FIG. 7 is a block diagram which illustrates a configuration example of hardware of a computer which executes the above described series of processes using a program.

In the computer, a Central Processing Unit (CPU) 201, a Read Only Memory (ROM) 202, and a Random Access Memory (RAM) 203 are connected to each other using a bus 204.

An input-output interface 205 is further connected to the bus 204. An input unit 206, an output unit 207, a recording unit 208, a communication unit 209, and a drive 210 are connected to the input-output interface 205.

The input unit 206 is formed of a keyboard, a mouse, a microphone, or the like. The output unit 207 is formed of a display, a speaker, or the like. The recording unit 208 is formed of a hard disk, a non-volatile memory, or the like. The communication unit 209 is formed of a network interface, or the like. The drive 210 drives a magnetic disk, an optical disc, and a magneto-optical disc, or a removable media 211 such as a semiconductor memory.

In the computer which is configured as described above, the above described series of processes is executed when the CPU 201 executes a program which is recorded in the recording unit 208 by downloading the program to the RAM 203 through the input-output interface 205 and the bus 204.

The program which is executed by the computer (CPU 201) can be provided to the removable media 211 as package media, or the like, for example, by recording the program. In addition, the program can be provided through a wired or wireless transmission medium such as a local area network, the Internet, and a digital satellite broadcast.

In the computer, the program can be installed in the recording unit 208 through the input-output interface 205 when the removable media 211 is mounted on the drive 210. In addition, the program can be received using the communication unit 209 through a wired or wireless transmission medium, and can be installed in the recording unit 208. In addition to that, the program can be installed in advance in the ROM 202, or the recording unit 208.

In addition, the program which is executed by the computer may be a program of which processes are processed in time sequence according to an order which is described in the specification, or may be a program of which processes are processed in parallel, or at a necessary timing, for example, when there is a call thereof.

In addition, the embodiment of the present technology is not limited to the above described embodiment, and various changes can be made without departing from the scope of the present technology.

For example, the present technology can adopt a configuration of cloud computing in which a plurality of devices share one function through a network, and cooperatively process the function.

In addition, each step which is described in the above described flowchart can be executed in one device, and can also be executed by being shared with a plurality of devices.

In addition, when a plurality of processes are included in one step, a plurality of processes which are included in the one step can be executed in one device, and can also be executed by being shared with a plurality of devices.

In addition, the present technology can also be configured as follows.

[1] An image processing device which includes a position determination unit which arranges a viewpoint image on a new coordinate system so that the same object on the viewpoint images is overlapped in each viewpoint, based on a plurality of image groups, each of which is formed of a plurality of viewpoint images with different viewpoints, and which have gaze points which are different from each other; and a composition processing unit which generates a stereoscopic image with a plurality of gaze points which is formed of a composite viewpoint image of each of the viewpoints, by generating the composite viewpoint image by compositing the plurality of viewpoint images which are arranged on the coordinate system, in each of the viewpoints.

[2] The image processing device which is described in [1], in which the image group in each of the gaze points is formed of a pair of viewpoint images, respectively, and has one convergence point.

[3] The image processing device which is described in [1] or [2], in which the composition processing unit generates the composite viewpoint image by performing an adding and averaging filtering process with respect to the viewpoint images by performing weighting corresponding to a position in a region in which the plurality of viewpoint images are overlapped.

[4] The image processing device which is described in any of [1] to [3], in which the plurality of image groups are photographed at the same point in time.

[5] The image processing device which is described in any of [1] to [3], in which the plurality of the image groups are photographed at a different point in time in each of the image groups.

### REFERENCE SIGNS LIST

41 PHOTOGRAPHING UNIT
42 IMAGE PROCESSING UNIT
43 DISPLAY CONTROL UNIT
44 DISPLAY UNIT
71 POSITION DETERMINATION UNIT
72 COMPOSITION PROCESSING UNIT
73 CUTTING UNIT

1. An image processing device comprising:
a position determination unit which arranges a viewpoint image on a new coordinate system so that the same object on the viewpoint images is overlapped in each viewpoint, based on a plurality of image groups, each of which is formed of a plurality of viewpoint images with different viewpoints, and which have gaze points which are different from each other; and
a composition processing unit which generates a stereoscopic image with a plurality of gaze points which is formed of a composite viewpoint image of each the viewpoint, by generating the composite viewpoint image by compositing the plurality of viewpoint images which are arranged on the coordinate system, in each the viewpoint.

2. The image processing device according to claim 1,
wherein the image group in each of the gaze points is formed of a pair of viewpoint images, respectively, and has one convergence point.

3. The image processing device according to claim 2,
wherein the composition processing unit generates the composite viewpoint image by performing an adding and averaging filtering process with respect to the viewpoint images by performing weighting corresponding to a position in a region in which the plurality of viewpoint images are overlapped.

4. The image processing device according to claim 3,
wherein the plurality of image groups are photographed at the same point in time.

5. The image processing device according to claim 3,
wherein the plurality of the image groups are photographed at a different point in time in each of the image groups.

6. An image processing method comprising the steps of:
arranging a viewpoint image on a new coordinate system so that the same object on the viewpoint image is overlapped in each viewpoint, based on a plurality of image groups, each of which is formed of a plurality of viewpoint images with different viewpoints, and which have gaze points which are different from each other; and
generating a stereoscopic image with a plurality of gaze points which is formed of a composite viewpoint image of each the viewpoint, by generating the composite viewpoint image by compositing the plurality of viewpoint images which are arranged on the coordinate system, in each the viewpoint.

7. A program which causes a computer to execute a process including the steps of:
arranging a viewpoint image on a new coordinate system so that the same object on the viewpoint images is overlapped in each viewpoint, based on a plurality of image groups, each of which is formed of a plurality of viewpoint images with different viewpoints, and which have gaze points which are different from each other; and
generating a stereoscopic image with a plurality of gaze points which is formed of a composite viewpoint image of each the viewpoint, by generating the composite viewpoint image by compositing the plurality of viewpoint images which are arranged on the coordinate system, in each the viewpoint.
